(19) United States
(12) Patent Application Publication
(10) Pub. No.: US 2026/0368629 A1
(43) Pub. Date: Nov. 19, 2026

(54) RANDOM OPTIMIZATION WEIGHT TUNING

(71) Applicant: Microsoft Technology Licensing, LLC, Redmond, WA (US)

(72) Inventors: Antonio G ALONSO, San Francisco, CA (US); David GOLLAND, Pittsburgh, PA (US); Mohit R KOTHARI, Campbell, CA (US); Ghulam Ahmed ANSARI, Fremont, CA (US)

(21) Appl. No.: 19/211,157

(22) Filed: May 17, 2025

(51) Int. Cl. G06N 20/00

(52) U.S. Cl. CPC G06N 20/00

(57) ABSTRACT

Aspects of the disclosure include a machine learning architecture for multi-objective model random optimization weight tuning and methods of using the same. A method includes receiving, by a global block ranker of a hybrid meta learning recommendation service, a request corresponding to an entity in a network. A meta block encoder generates, at a first cadence decoupled from the request, a meta embedding of an entity-specific meta feature of the entity. The meta embedding is aggregated with one or more non-meta features at a second cadence responsive to the request and the aggregated data is input to the global block ranker. A prediction score is generated for each candidate of one or more candidates corresponding to the request and a response including a candidate is returned using the prediction score.

The subject disclosure relates to machine learning, connections networks, and content recommendation, and specifically to a machine learning architecture for multi-objective model random optimization weight tuning.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 is a functional block diagram illustrating an example of a feed service with which an embodiment of the present disclosure may be implemented and deployed;

FIG. 2 depicts a random optimization (RO) weight tuning model for the feed service of FIG. 1 in accordance with one or more embodiments;

FIG. 3 depicts a weight mutation module for the RO weight tuning model of FIG. 2 in accordance with one or more embodiments;

FIG. 4 depicts an evaluation module for the RO weight tuning model of FIG. 2 in accordance with one or more embodiments;

FIG. 5 depicts a debiasing module for the evaluation module of FIG. 4 in accordance with one or more embodiments;

FIG. 6 depicts a block diagram of a multilayer perceptron (MLP)-type model implementation in accordance with one or more embodiments;

FIG. 7 depicts a block diagram of a transformer-type model implementation in accordance with one or more embodiments;

FIG. 8 depicts a block diagram of a computer system in accordance with one or more embodiments; and

FIG. 9 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying FIGURES and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Online platforms such as connections networks face significant technical challenges related to content serving due in part to the enormous scale of these systems and the sheer variety and amount of candidate content available for delivery to users. To illustrate these challenges, consider that online platforms would ideally serve only desired content to users (that is, content for which the receiving user is pleased to receive). Therefore, to improve the desirability of delivered content, candidate content (also referred to as candidate items) might be evaluated, scored, ranked, and ultimately delivered to the users of the underlying platform according to their respective rankings. Evaluating and ranking candidate content is technically challenging, however, due to a number of factors. One of the technical challenges associated with the ranking of candidate content is simply the diversity and volume of content available for serving to users, especially when considering seasonal member interests and trends. Put simply, it is not straightforward to rank varied candidate content of differing types and/or modalities in a consistent manner.

One approach to this technical problem is to design and implement one or more models trained to predict a user's likelihood to interact with candidate content-whether through clicks, likes, comments, shares, reposts, and/or skipping the content. A multi-objective model can assign scores to candidate content by multiplying these underlying probabilities (e.g., probability to click, probability to like, etc.) by corresponding importance weights, resulting in a final ranking that can be leveraged for content serving. A naïve approach to this sort of multi-objective scoring system would be to manually adjust the importance weights and to evaluate the outcome via online or offline analysis. This approach is somewhat limited however, and is natively constrained by non-granularity (the lack of fine detail or precision in the manual adjustment of importance weights in a multi-objective scoring system) and the defined fitness rewards, which can themselves be subject to biases by modelers.

An alternative to the naïve approach of manually adjusting importance weights is to use a machine learning architecture that employs a random optimization technique(s) to learn the weights. Random optimization refers to a class of optimization techniques that use random processes to explore a solution space to find optimal or near-optimal solutions to a problem. In the context of recommender systems, these techniques, including the use of genetic algorithms, random hill climbing, and/or simulated annealing, automate the process of importance weight tuning by exploring a wide range of possible weight configurations and selecting those that optimize the underlying model's performance based on predefined objectives. This process can be referred to generally as exploration-exploitation, where exploration (also referred to as an exploration phase) refers to the testing of a wide range of possible weight configurations and exploitation (also referred to as an exploitation phase) refers to the selection and application of the weights, discovered during exploration, that optimize model performance.

While random optimization techniques such as genetic algorithms, random hill climbing, and simulated annealing provide automated and systematic approaches to weight tuning, they are not without limitations. Conventional implementations of these techniques often lack the ability to effectively handle the complexity and variability inherent in multi-objective optimization problems. For instance, traditional genetic algorithms may suffer from premature convergence, where the algorithm settles on suboptimal solutions due to a lack of diversity in the population. Random hill climbing can be limited by its tendency to get stuck in local optima, as it only makes incremental changes to a single solution. Simulated annealing, while capable of escaping local optima, may require extensive computational resources and time to achieve convergence, especially in large and complex solution spaces. Additionally, these methods typically do not incorporate domain-specific knowledge or constraints, which can lead to inefficient exploration of the solution space.

The present invention addresses these limitations by introducing a variant to the conventional random optimization model. More specifically, this disclosure introduces a modified random optimization machine learning architecture for random optimization weight tuning of a multi-objective model having enhancements such as a per-objective sensitive epsilon values, focused exploration objectives, and mutation distribution constraints to improve the efficiency, precision, and applicability of these optimization techniques in the context of recommendation systems. Advantageously, the random optimization model architecture described herein is modified to focus the exploration phase according to objective expectations (referred to herein as focused exploration). For example, in a content recommendation setting for a connections network, the predicted share probability (p-share) is an inherently positive objective and the exploration phase can be constrained to ignore explorations which do not maximize this value. Additionally, or alternatively, the exploration phase can be constrained to ignore explorations which tend to increase inherently negative objectives (e.g., ignores, hides, etc.). Of course, these examples are merely illustrative, and optimizations can be added to limit the exploration space of inherently positive and negative objectives in any manner desired.

Another technical advantage of the modified random optimization weight tuning model described herein is the introduction of a per-objective sensitive epsilon. In the context of random optimization, a basket of initial importance weights is initialized (that is, initial values are set) and then modified (referred to as mutated) over a series of generations. More specifically, a generation refers to a single iteration or cycle within this process and, during each generation, a population of candidates, often referred to as individuals or children, is evaluated for their fitness based on predefined objectives. The fittest individuals are selected to form a new generation through processes such as crossover (recombination) and mutation. Here, mutation refers to an operator used to introduce diversity into the population of candidate solutions and involves making random or predetermined changes to the attributes or parameters of an individual solution. In the context of weight tuning for a multi-objective model, for example, mutation might involve altering the weights assigned to different objectives. This iterative process continues over multiple generations, with each generation ideally improving upon the previous one, gradually evolving towards an optimal or near-optimal solution. Continuing with this previous example, an optimal solution can include a selection of importance weights for a multi-objective model which tend to maximize one or more predetermined objectives.

In this context, epsilon refers to the constraint placed on mutation drift for each generation. In other words, epsilon dictates the scale of perturbations at each step of the random optimization process. Traditional random optimization relies on cross over (randomly mixing each parameter) or blanket mutations. In a sense, these rely on a global epsilon value during these mutations, meaning that all objectives will randomly shift by respective values within the same range. Allowing each objective to have its own sensitivity epsilon, tuned via exploration, can improve variance between runs and the reproducibility of results, offering a significant improvement over currently available random optimization processes and systems.

Other technical advantages of the modified random optimization weight tuning model described herein include interaction debiasing, global vs. session aggregation, and the introduction of mutation distribution constraints to random optimization, each discussed in turn below.

Interaction debiasing refers to a new way to indirectly evaluate noisy proxies for underlying objectives which are themselves difficult to measure directly. For example, in a connections network, total user engagement (defined, e.g., as the overall level of interaction and involvement a user has with a platform or service) might be the true objective, but assessing total user engagement directly might be difficult. To solve this problem, profession interactions (PI) might be used as a proxy for total user engagement (also referred to as sessions or a session metric). While not meant to be particularly limited, a “professional interaction” refers to a weighted aggregation of user feedback on the underlying platform, such as, for example, a number of clicks, likes, comments, shares, dwell time (time spent consuming a piece of content), etc. made by a user. Unfortunately, in many real-world cases, the chosen proxy (e.g., professional interactions) can contain noisy and/or biased data, leading to a poor assessment of the true, underlying objective. For example, in context of recommendation systems, professional interactions might be naturally biased towards content which maximizes dwell time because there are simply more data points related to dwell time than other PI metrics (e.g., there are less data points for shares, likes, etc. than for dwell time because all content will have a dwell time, but not all content will be liked, shared, etc.), meaning that relying on a conventional random optimization reward function when evaluating PI will tend to bias the multi-objective model towards content which maximizes dwell time (that is, towards longer content). Advantageously, rather than evaluating the chosen proxies (e.g., PI metric(s)) directly, a new reward function is defined which introduces an inverse log rate to debias the skew that some objective metrics can introduce when those metrics dominate (that is, when those metrics are more frequent than other selected metrics, such as dwell time in the prior example). It has been found that leveraging an inverse log rate when scoring objectives for content selection can improve the number and quality of user interactions to impressed content, representing another significant improvement over currently available random optimization processes and systems.

Finally, global vs. session aggregation refers to a modification to the conventional random optimization fitness function which allows the random optimization weight tuning model to quantify and learn the difference between individual member session level metrics and relatively longer-term, global metrics. In short, conventional random optimization techniques rely on a fitness function that evaluates all data equally. This may work in some contexts but can fail when the data is natively segmented into two or more classes having different characteristics or behaviors. To illustrate, consider that, in a recommendation system, a longtime user may log into a platform with a specific goal in mind (e.g., job seeking), and may take a series of actions within a single user sign-on motivated by that goal. Later (or before), that same user might not be using the platform for job seeking (perhaps after a job is secured) but might instead repeatedly use the platform for a different purpose (e.g., network building). Conventional random optimization techniques rely on fitness functions which treat all of the user actions equally, meaning that these systems can fail to capture changes in short term behaviors confined within single session data (especially when those more short-term behaviors do not align with the longer-term user behavior captured over many sessions). In contrast, the modified random optimization weight tuning model described herein splits the data into two or more classes, such as session vs. non-session data, prior to evaluating fitness. As used herein, “session” data refers to data collected at the level of individual user sessions (e.g., what user interactions were made by a particular user on a platform within the context of a single sign-on), while “non-session” data refers to data collected over the course of many sessions (and for any number of users). Advantageously, modifying the fitness evaluation in this manner greatly improves the ability of the underlying model to adapt to short term changes in user behavior, resulting in better recommendations which are more in tune with a user's current requirements and expectations. Moreover, data can be collected and fitness can be analyzed at the level of individual user sessions while still allowing fallback to the more conventional global level for use cases where individual session level metrics are not available (or are not available at the quantity desired), such as, for example, scenarios with a small number of unique viewers (e.g., first unique viewers, FUV) and/or short session lengths.

Mutation distribution constraints refers to a new constraint that, during random optimization exploration (that is, when modifying one of the weights), the resulting distribution must always sum to 1. This is a departure from conventional random optimization techniques, which do not place constraints on these distributions, and which do not typically involve normalization.

### DETAILED EMBODIMENT

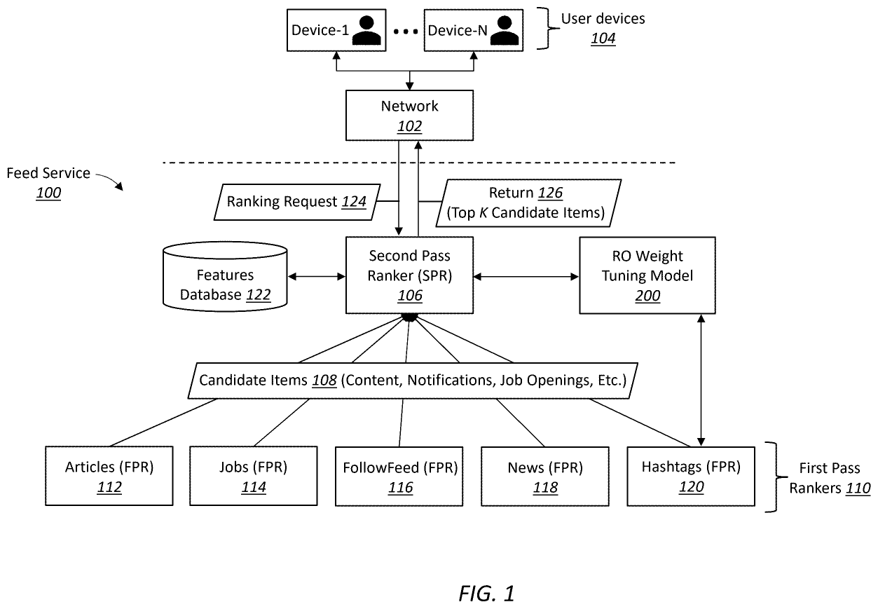

FIG. 1 is a functional block diagram illustrating an example of a feed service 100 in which an embodiment of the present invention may be implemented and deployed. The feed service 100 can be used to serve content over a network 102 to user devices 104. Feed service 100 can be a large-scale online service serving many users (e.g., thousands of users, millions of users, hundreds of millions of users, or more). In some embodiments, the feed service 100 may be used to customize a content feed to the attributes, behavior, and/or interests of members or related groups of members (e.g., connections, follows, schools, companies, group activity, member segments, etc.) in a connections network, social network and/or online professional network, as desired. The type of content served is not meant to be particularly limited, but can include, for example, connection recommendations (e.g., people you may know), user profiles and/or links to user profiles, job postings, user posts, status updates, user and/or system messages, sponsored content, event descriptions, articles, images, audio data, video data, documents, and/or other types of content.

Network 102 can include a data communications network and can encompass one or more different types of networks. For example, network 102 can encompass one or more cellular networks (e.g., GSM, IS-95, UMTS, CDMA2000, LTE, 5G, etc.), one or more wireless networks (e.g., an IEEE 802.11 network), and/or one or more internet protocol (IP) networks (e.g., the Internet).

User devices 104 (e.g., Device-1, Device-2, . . . , Device-N) can include many different types of electronic and personal computing devices. For example, a user device 104 can be stationary computer such as a desktop or workstation computer or the like. A user device 104 can be a portable computer such as a laptop computer, a tablet computer, a mobile phone, a smart phone, or the like. A user device 104 can include, or be operatively coupled to, a computer display screen on which a graphical user interface (GUI) driven by the feed service 100 can be presented to a user via the user device 104. The graphical user interface can encompass web pages, web content, or the like served by the feed service 100 to user devices 104 over network 102. The online service can drive the graphical user interface with the aid of a client application that is installed and executing the user device 104. The client application can be a web browser application or a mobile application, for example.

As shown in FIG. 1, feed service 100 can include a second pass ranker (SPR) 106. In some embodiments, SPR 106 is configured to score and select content for serving to the user devices 104 over the network 102. In some embodiments, the SPR 106 operates by re-ranking candidate items 108 that have been preliminarily selected by one or more first pass rankers (FPRs) 110. This re-ranking process ensures that the most relevant and engaging content is prioritized for delivery to the user devices 104. In some embodiments, SPR 106 is configured to combine and score the output from one or more, or even all, of the FPRs 110.

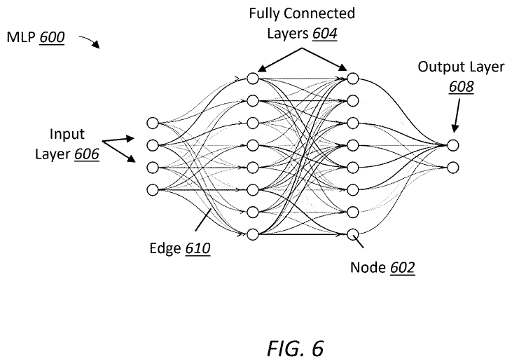

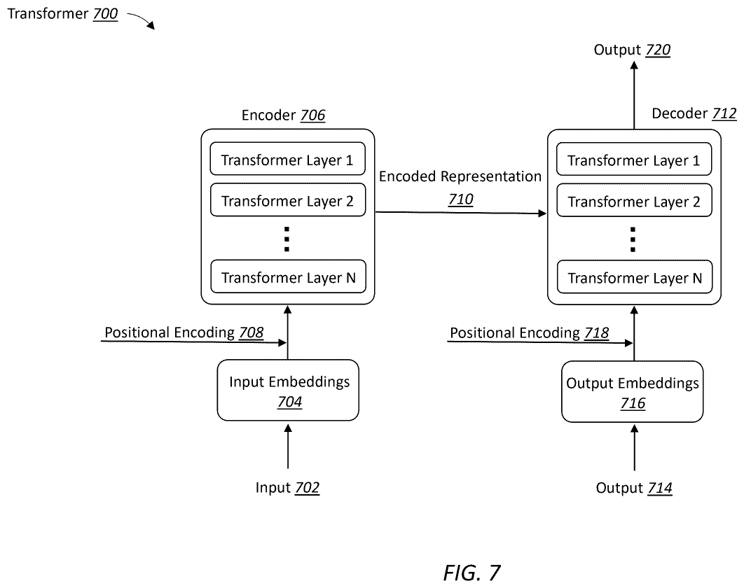

The primary function of the FPRs 110 is to quickly and efficiently filter and rank a large pool of potential content items. In some embodiments, the FPRs 110, in contrast to the SPR 106, are each specialized in handling a specific type of content, such as articles, job postings, user posts, sponsored content, etc. The FPRs 110 operate by querying data stores to retrieve content items that match certain criteria relevant to the user. These criteria can include user preferences, past interactions, content attributes, and other contextual information. In some embodiments, each FPR 110 applies its own learned and/or heuristic ranking algorithm to score and rank the retrieved content items, producing a preliminary list of candidate items 108. This initial ranking can be based on features such as a user's engagement history, the popularity of the content, and the relevance of the content to a user's current context. For example, in some embodiments, FPRs 110 create a preliminary candidate selection (the candidate items 108) from their shared or segmented inventories based on predicted relevance to the intended user of the users 104. The candidate items 108 can be ranked using parameters related to the user's connections, groups, follows, activities, interests, associated companies, etc., in the underlying connections network, as well as other parameters such as updates made to the user's profile, job status, etc., skill recommendations by other users on the network, etc. For example, a news-type FPR might create a list of preliminary candidate news items for a user based on personalized user features such as the types and length of news content consumed by the user in the last 1, 5, 30 days, etc., in addition to non-personalized features, such as, for example, the length of a candidate news item, the type of content of a candidate news item, the time of day, the day/month of the year, etc. While not shown for simplicity, the FPRs 110 can operate on raw data (that is, directly on the underlying documents, articles, etc.) or can operate on embeddings of the raw data (refer, e.g., to FIGS. 6 and 7 for a discussion of embeddings).

In the example of FIG. 1, first pass rankers 110 include an articles first pass ranker 112 for scoring article feed items, a jobs first pass ranker 114 for scoring job feed items, a followfeed first pass ranker 116 for scoring follow feed items, a new first pass ranker 118 for scoring news feed items, and a hashtags first pass ranker 120 for scoring hashtag feed items. Article feed items scored by articles first pass ranker 112 can include user authored articles, scholarly articles, informational articles, and other types of written articles. An article feed item can contain, or link to, the text of an authored article and any associated media. Job feed items scored by the jobs first pass ranker 114 can include job opening, job postings, job listings, employment opportunities, or the like. A job feed item can contain, or link to, a text description of the job such as, for example, job requirements and any associated media. In-network items scored by the first pass ranker 116 can include activities by users interacting with feed items in their personalized feeds (e.g., follow feed items). Such feed item interaction activities can include, but are not limited to, liking a feed item, sharing a feed item with one or more other users in a connections network, commenting on a feed item, and clicking on (viewing) a feed item, etc. An in-network item can contain, or link to, a text description of a user activity and any associated media. News feed items scored by news first pass ranker 118 may include news articles, news reports, or the like. A news feed item can contain, or link to, the text of the news article and any associated media. Hashtag feed items scored by hashtags first pass ranker 120 may include social network posts, comments, tweets, photo shares, or the like that include different hashtags (e.g., “#moving”, “#selfie”, “#happy”) or other types of metadata or hashtags. A hashtag feed item can contain, or link to, the text containing a hashtag or metadata tag. First pass rankers 110 shown in FIG. 1 are provided merely as an example of a possible set of first pass rankers that can be used in the feed service 100. It should be understood that more first pass rankers, or less, or an entirely different set of first pass rankers can be used in a particular implementation, as desired. More or fewer first pass rankers 110 can also be used in a particular implementation. For example, as few as a single first pass ranker 110 can be used in an implementation. Alternatively, more than five (5) first pass rankers 110 can be used in an implementation, such as 10, 20, 100, etc. In addition, it is not necessary for a first pass ranker 110 to score a homogeneous type of feed items, and a single first pass ranker 110 can score heterogeneous types of feed items. For example, a single first pass ranker 110 can be used to score all of article feed items, jobs feed items, follow feed items, news feed items, and hashtag feed items, as desired.

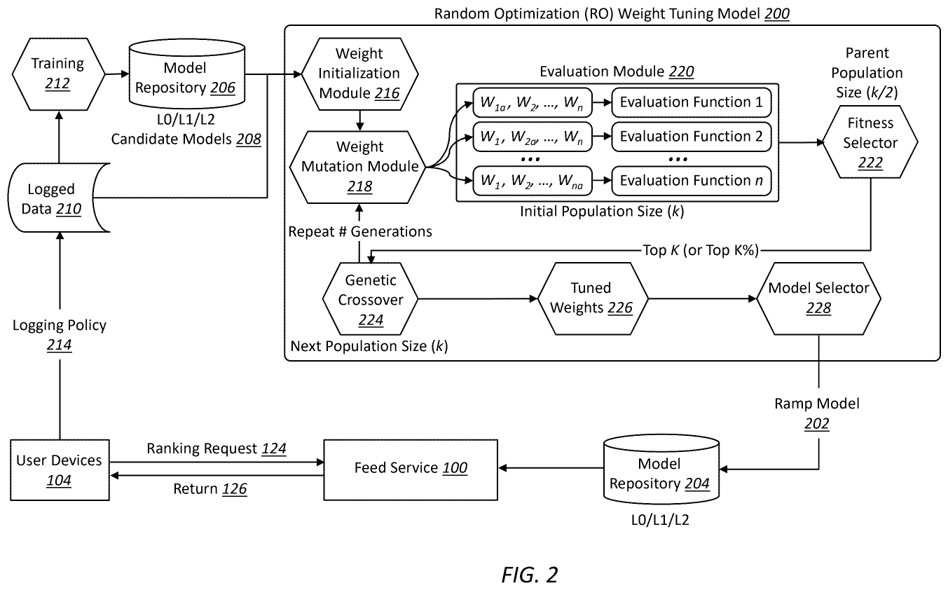

Returning now to the SPR 106, in some embodiments, SPR 106 includes one or more models selected for online serving (referred to as ramped) from a plurality of candidate models trained or heuristically tuned to rank the candidate items 108 (refer to FIG. 2). In some embodiments, the ramped model(s) are selected according to an output of a random optimization weight tuning model 200 (refer to FIG. 2). Once ramped, the SPR 106 can leverage a combination of supervised learning, unsupervised learning, and other machine learning techniques to rank the candidate items 108. Note that, while primarily discussed with respect to ramping models (or model version updates) for the SPR 106, the random optimization weight tuning model 200 can be similarly leveraged to ramp models for any (or all) of the first pass rankers 110.

In some embodiments, when scoring (or re-scoring) the candidate items 108, the SPR 106 can accept a variety of different machine learning features as input. The features accepted as input can include, but are not limited to, features of the intended user (“viewer features”), features of the candidate item (“feed item features”), features of both the user and the feed item (“viewer-feed item features”), features of the actor associated with the candidate item (“actor features”), features of both the user and the actor of the feed item (“viewer-actor features”), features combining aspects of each of the viewer, the actor, and the feed item (“viewer-actor-feed item features”), and global features. Note that, as used herein, the “actor” of a candidate item refers to the entity (e.g., another user, a company, an advertiser, etc.) that took the action(s) that caused the respective feed item to be served to the user. Note that, in some cases, the actor and the user are the same entity. On the other hand, in other scenarios, the actor and the user are different entities. In still other cases, there is no actor per se, as the feed items might be served to the user according to user and/or candidate item features and a predetermined schedule. In some embodiments, features can be stored in a features database 122 accessible to the feed service 100 and/or second pass ranker 106. In some embodiments, features database 122 can also be accessible to one or more of the first pass rankers 110.

In some embodiments, a ranking request 124 (also referred to as a personalized feed request) can be sent from or on behalf of a user device 104 (e.g., Device-1, . . . , Device-N) over network 102 to the feed service 100 and/or second pass ranker 106. In some embodiments, ranking request 124 includes a request to provide the top K candidates of a plurality of candidates (e.g., the candidate items 108) for delivery to the user device 104. In some embodiments, SPR 106 can, responsive to receiving the ranking request 124, return 126 (e.g., “surface”, or “impress”) one or more candidate items 108 to the user device 104 over network 102, where a user can view or otherwise interact with the associated content items. The ranking request 124 can be carried in one or more hypertext transfer protocol (HTTP) requests or one or more secure-hypertext transfer protocol (HTTPS) requests. Similarly, in some embodiments, the return 126 for the personalized feed request can be sent from the feed service 100 and/or second pass ranker 106 over network 102 to the associated user device 104 in one or more HTTP or HTTPS responses. The present disclosure is not limited to HTTP or HTTPS for sending and responding to feed requests, as these are merely illustrative. Other suitable application-layer protocols can be used such as, for example, an application-layer protocol suitable for implementing remote procedure calls (RCPs) or messaging queuing (e.g., the Advanced Message Queuing Protocol (AMQP)).

FIG. 2 depicts a random optimization weight tuning model 200 for the feed service 100 of FIG. 1 in accordance with one or more embodiments. As shown in FIG. 2, the random optimization weight tuning model 200 can be leveraged to select a model(s) (referred to as ramp model 202) for the feed service 100 from one or more candidate models stored in a model repository 204. The ramp model 202 can include first pass rankers (sometimes referred to as L1 models), second pass rankers (sometimes referred to as L2 models), and/or initial candidate fetching models (also referred to as L0 models), and can be stored in the model repository 204 in a manner that is accessible to the feed service 100. In some embodiments, initial versions (e.g., prior to RO weight tuning) of the ramp model 202, as well as other models, can be stored in a model repository 206 accessible to the random optimization weight tuning model 200. The model repository 206 can be the same repository, or a different repository, than the model repository 204.

In some embodiments, model repository 204 and/or model repository 206 are experimental model repositories having stored therein a number of candidate models 208 for the feed service 100. In some embodiments, candidate models 208 (also referred to as experimental models) within the model repository 206 are multi-objective models that are trained on logged data 210 (also referred to as training data) during a training phase (training 212). In some embodiments, logged data 210 is collected from user devices 104 according to a logging policy 214. A logging policy 214 refers to the set of rules or guidelines that dictate how data, such as user interactions on a connections network, are recorded and stored during the operation of the user device 104 and/or the feed service 100. The logging policy 214 determines which events or actions are captured, how frequently data is logged, the level of detail included in the logs, etc. The logging policy 214 underlying the logged data 210 therefore governs the selection of training data for training 212 the candidate models 208 within the model repository 204. For example, in a content recommendation system, a logging policy 212 might specify that every time a user clicks on a recommended article, the event is logged along with metadata such as the time of the click, a user identifier, an article identifier, and/or any number of the user's previous interactions with similar content (as determined, e.g., according to a number of shared characteristics and/or a distance measure in an embedding space). In this scenario, logged data 210 can then be used to train candidate models 208 to predict user article preferences, thereby improving the accuracy of future article recommendations.

In any case, as further shown in FIG. 2, one or more of the candidate models 208 and, optionally, the logged data 210, can be transmitted to, or fetched by, the random optimization weight tuning model 200. In some embodiments, at least two candidate models 208 are served to the random optimization weight tuning model 200. The random optimization weight tuning model 200 selects, from the at least two candidate models 208, the one or more ramp model(s) 202. Model selection is discussed in greater detail herein.

In some embodiments, the candidate models 208 and, optionally, the logged data 210 are passed to a weight initialization module 216. The weight initialization module 216 establishes a starting point for model weights prior to weight tuning. Weight initialization module 216 may employ various strategies to set these initial weights. For instance, weight initialization module 216 can be configured for random initialization within a specified range, such as setting weights between 0.1 and 0.3 (or between 0.2 and 0.9, etc.), to introduce variability and to prevent premature convergence to suboptimal solutions (local minimums). Alternatively, or in addition, the weight initialization module 216 can leverage historical data (e.g., logged data 210) to initialize weights based on the known past performance of one or more prior models (e.g., a prior version of a candidate model 208, etc.). For example, weight initialization module 216 can initialize the weights to the same weights as used in a prior model, or can initialize weights by assigning higher initial values to weights associated with actions that historically led to positive outcomes, such as clicks or shares, or can initialize weights randomly and then adjust those weights by applying a bias to weights associated with actions that historically led to positive outcomes (or a negative bias to weights associated with negative outcomes, etc.). For example, in a content recommendation system, the weight for the probability of a user clicking on a post might be initialized to 0.2, while the weight for the probability of a user liking a post could be set to 0.1. An example set of initialized weights might be: [0.1, 0.6, . . . , 0.2]. In any case, these initial weight values can reflect the relative importance or expected impact of these actions on overall model performance, guiding the later random optimization process towards configurations that enhance user engagement and satisfaction (or any other desired metric).

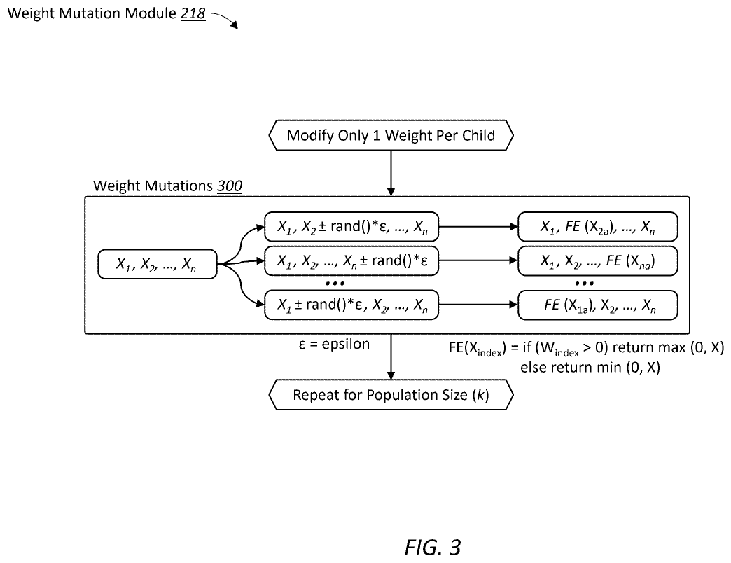

In some embodiments, the initialized weights (also referred to as parent weights in some contexts, such as for genetic algorithms) are passed to a weight mutation module 218. In some embodiments, weight mutation module 218 generates, from the initialized weights, a weight mutation (also referred to as child weights, or next generation weights, refer to FIG. 3). A weight mutation refers to the process of altering the initial weights of a model (e.g., the initialized weights) to create new candidate solutions (referred to as children) during a random optimization process. Building a weight mutation involves making changes, often small and/or random, to a set of incoming or initial weights, resulting in a new set of weights which can lead to variations in the underlying model's performance. The process can be repeated to generate any number of weight mutations, each resulting in a candidate set of child weights that can be evaluated (refer to evaluation module 220). The purpose of the weight mutations is to allow the random optimization weight tuning model 200 to explore the solution space, thereby providing a path to identify weight configurations that improve the underlying model's effectiveness in achieving its predetermined objectives (e.g., increase click rate, likes, etc.).

In some embodiments, the weight mutation module 218 only modifies a single weight per child. Continuing with the previous example, the initial weights [0.1, 0.6, . . . , 0.2] can be used to generate the weight mutations [0.08, 0.6, . . . , 0.2], [0.1, 0.61, . . . , 0.2], and [0.1, 0.6, . . . , 0.17]. This process can be repeated to generate any number of child weights. The set of all child weights can be referred to as the initial population size (k), which can be set to any desired value (e.g., 10, 100, 1000, etc.). The weight mutation module 218 and the generation of weight mutations is discussed in greater detail with respect to FIG. 3.

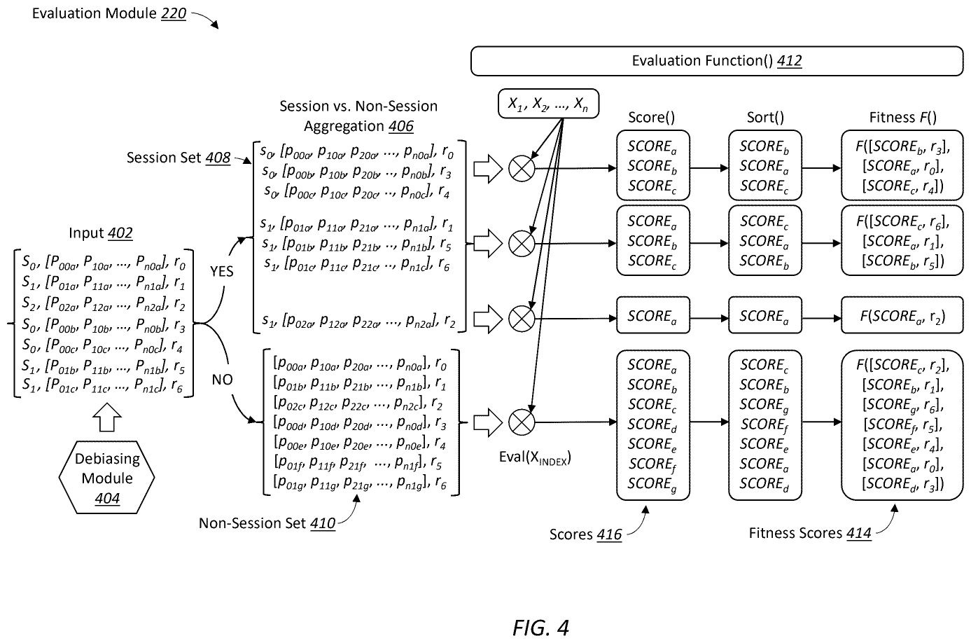

In some embodiments, the weight mutations are passed to an evaluation module 220. The evaluation module 220 generates, from the weight mutations, a number of evaluation functions (e.g., evaluation function 1, evaluation function 2, . . . , evaluation function n for n total evaluation functions). The number of evaluation functions n can be the same, or different, than the initial population size k. In some embodiments, the evaluation functions are fitness scores for the various candidate weight mutations. The evaluation module 220, and the generation of the evaluation functions, is discussed in greater detail with respect to FIG. 4.

In some embodiments, the evaluation functions (or fitness scores) from the evaluation module 220 are passed to a fitness selector 222. In some embodiments, fitness selector 222 selects, from the fitness scores, a subset of scores having the K highest values (referred to herein as the top K scores). The fitness selector 222 can be configured to select any proportion (including all) of the fitness scores. In other words, K can be set as desired. In some embodiments, fitness selector 222 selects the top 50 percent of children on fitness score (also referred to as top K %, or as K/2). In this configuration, the top K scores have a population size of k/2 (referring to the initial population size k).

In some embodiments, the top K scores (or top K %) of the fitness scores are passed to a genetic crossover module 224 (or simply, genetic crossover 224). In some embodiments, genetic crossover 224 generates new candidate children from the selected top K scores. While not meant to be particularly limited, genetic crossover involves the exchanging of segments of a parent solutions' weight configurations to create new candidate solutions. Often, this step involves finding the best features of the parents' candidate solutions via top K scores and mutating to form new children. This can be achieved through various crossover techniques, such as single-point crossover, multi-point crossover, or uniform crossover. In a single-point crossover, a random crossover point is selected along the weight vector, and the weights from the two parents are swapped at this point to form two new children. For example, if Parent A has weights [0.2, 0.4, 0.6] and Parent B has weights [0.3, 0.5, 0.7], a single-point crossover at the second position might produce children with weights [0.2, 0.5, 0.7] and [0.3, 0.4, 0.6]. In a multi-point crossover, multiple crossover points are chosen, allowing for more complex combinations of parent weights. Uniform crossover, on the other hand, involves randomly selecting each weight from either parent with equal probability, resulting in a child that is a more balanced mix of both parents. Combinations of theses techniques can also be used.

In some embodiments, the resulting set of scores (referred to as child weights, or next generation weights) can be passed back to the weight mutation module 218 to provide a set of new parent weights for the random optimization process (e.g., the progression between weight mutation module 218, evaluation module 220, and fitness selector 222). Thus, the random optimization process can be repeated for any number of desired generations. In some embodiments, the random optimization process is repeated iteratively in this manner for a predetermined number of generations (e.g., 10, 100, 1000, etc.), although other stopping criteria, such as stopping when the fitness scores achieve some predetermined threshold (e.g., average score of top K greater than a predetermined threshold, lowest score of top K greater than a predetermined threshold, etc.), are within the contemplated scope of this disclosure.

Once the random optimization process completes the final generation, the resulting tuned wights 226 can be passed to a model selector 228. In some embodiments, the model selector 228 selects one or more ramp models 202 according to the tuned weights 226. While not meant to be particularly limited, model selector 228 might select, for example, the candidate model(s) having the highest fitness scores. However selected, the ramp model 202 can be stored in the model repository 204 and/or can be passed to feed service 100 to update one or more online models (e.g., to update the SPR 106 and/or one or more of the first pass rankers 110, refer to FIG. 1).

FIG. 3 depicts a weight mutation module 218 for the RO weight tuning model 200 of FIG. 2 in accordance with one or more embodiments. More specifically, FIG. 3 illustrates one method for generating weight mutations 300 via a genetic evolution-based process. In this approach, a population of initial weights (e.g., weights from weight initialization module 216 and/or iterative child weights from genetic crossover 224, such as the weights [X₁, X₂, . . . , Xₙ]) is received, and mutations are introduced by altering the weights. For example, if a weight for the probability of a user clicking on a post is initially set at 0.2, a mutation might adjust this weight to 0.22 or 0.18, depending on the mutation strategy and the desired exploration intensity.

In some embodiments, weight mutations 300 are generated by adding or subtracting a value to or from each weight, thereby creating a new set of child weights. In some embodiments, the value added or subtracted from each of the respective weights is random. In some embodiments, the random value added or subtracted from respective weights is scaled according to a predetermined constraint on per-generation mutation drift, referred to herein as the epsilon value. For example, the weights [X₁, X₂, . . . , Xₙ]) can be modified to generate new child weights [X₁, X₂±rand( )*ε, . . . , Xₙ], where rand( ) denotes a random number selection from a predetermined range (e.g., 0 to 1). This process can be repeated for any number of desired children per generation, each having a single weight mutation.

Unlike conventional random optimization architectures, which rely on a single epsilon value (referred to herein as a global epsilon value), in some embodiments, the epsilon value is a dynamic value which is learned individually for each underlying objective measure (e.g., a first epsilon value can be learned to predict a click rate, and a second epsilon value can be learned to predict a like rate). In other words, epsilon can be a local, non-global value which is learned for each of the weight mutations 300. In some embodiments, an initial value for epsilon is defined and/or a range of potential epsilon values is predetermined. A learning process begins by applying these epsilon values sequentially to generate weight mutations across different generations. The performance of each mutated solution can then be evaluated using a fitness function tailored to the specific objective measure, such as click rate or like rate (refer to fitness selector 222). In some embodiments, the various epsilon values are themselves compared against the corresponding fitness scores, and the epsilon value(s) resulting in the most significant improvements in fitness can be selected for further generations. Thus, epsilon itself can mutate over time alongside the weights at each generation. In other words, epsilon can be refined using a feedback loop in which epsilon is progressively changed based on observed performance trends. For instance, if relatively larger epsilon values result in better fitness scores, the epsilon value or epsilon range can be shifted towards higher values. Conversely, if smaller perturbations yield more stable improvements, the epsilon value or epsilon range can be narrowed to focus on finer adjustments. This adaptive process can continue iteratively, allowing the weight mutation module 218 to converge on an epsilon value that balances the need for exploration of new solutions against the exploitation of the resulting models.

In some embodiments, the weight mutation module 218 only modifies a single weight per child. For example, initial weights [X₁, X₂, . . . , Xₙ] can undergo various mutations to generate the child weights [X₁, X₂±U(0, W₂), . . . , Xₙ], [X₁, X₂, . . . , Xₙ±U(0, Wₙ)], and [X₁+U(0, W₁), X₂, . . . , Xₙ]. In some embodiments, each child includes a weight mutation for a different weight, although other configurations, such as those in which two or more children have different weight mutations against the same underlying weight, are possible and within the contemplated scope of this disclosure.

In some embodiments, the weight mutations 300 are further constrained (in addition to the epsilon constraints already discussed) by a focused exploration (FE) objective. In contrast to traditional random optimization techniques, which do not place native safeguards on exploration, a focused exploration objective can be defined to guide the per-generation mutations. More specifically, in some embodiments, a focused exploration objective is defined conditionally to maximize positive weights while minimizing negative weights. Functionally, the focused exploration objective can be defined as: FE(X_{index})=if (W_{index}>0) return max (0, x), else return min (0, x). Thus, each child weight can be passed through the focused exploration objective to generate the final child weights. For example, the initial child weights [X₁, X₂±rand( )*ε, . . . , Xₙ] can be used to generate final child weights [X₁, FE(X₂), . . . , Xₙ], where FE( ) is defined as above.

In some embodiments, the weight mutations 300 are further constrained (in addition to the epsilon constraints and/or FE objectives already discussed) such that, during exploration (that is, while modifying one or more of the weights), the distribution of weights must sum to one. This constraint can be referred to as a mutation distribution constraint. For example, consider a scenario with four weighted objectives: likes, comments, shares, and dwell time. The initial weights might be 0.2, 0.25, 0.4, and 0.15, respectively. Observe that these initial weights sum to one. Now, application of the mutation distribution constraint forces weight mutations, which are normally random, to respect the summation target. For example, lowering the first weight 0.2 to 0.15 means that the other weights must increase by a total of 0.05. Notably, traditional random optimization techniques do not place distribution constraints on exploration. Advantageously, applying a mutation distribution constraint in this manner serves as a sort of inherent normalization to the mutation process, which has been found to improve the accuracy of the underlying model.

It should be understood that, while FIGS. 2 and 3 are primarily discussed in the context of genetic algorithms, the random optimization weight tuning techniques described herein are applicable to any random optimization technique, such as, for example, random hill climbing and simulated annealing-based techniques. In other words, various techniques can be employed to generate the weight mutations 300, each with its own approach to exploration and exploitation of the solution space.

Random hill climbing, for example, involves iteratively improving a single solution by making small, random changes to the underlying weights. In this approach, if a mutation results in a better-performing solution, the mutation is accepted; otherwise, it is discarded. Random hill climbing is particularly useful for fine-tuning solutions that are already close to optimal. For instance, if a weight for user engagement is set at 0.3, a random hill climbing mutation might adjust it to 0.31, and if this change improves the model's performance, it is retained. Simulated annealing, in contrast, introduces mutations by allowing for occasional acceptance of worse solutions to escape local optima. This type of technique gradually reduces the probability of accepting worse solutions as the optimization process progresses, mimicking the cooling process of annealing in metallurgy. Each of these methods offers distinct advantages and can be selected based on the specific requirements of a given optimization task, such as the need for exploration versus exploitation, the complexity of the solution space, and the desired convergence speed.

FIG. 4 depicts an evaluation module 220 for the RO weight tuning model 200 of FIG. 2 in accordance with one or more embodiments. As shown in FIG. 4, evaluation module 220 can receive, from the weight mutation module 218, the logged data 210, and model repository 206, an input 402 that includes session-level predictions and corresponding rewards. For example, input 402 can include a first session S₀ having predictions [p₀₀ₐ, p₁₀ₐ, . . . , pₙ₀ₐ] and reward r₀, a second session S₁ having predictions [p₀₁ₐ, p₁₁ₐ, . . . , pₙ₁ₐ] and reward r₁, and so on. While not meant to be particularly limited, the predictions might be predictions for click rate, like rate, comment rate, etc. for candidate content. Notably, each session can include more than one prediction, such as the first session S₀ further including a prediction [p_{00b}, p_{10b}, . . . , p_{n0b}] with reward r₃ and a prediction [p_{00c}, p_{10c}, . . . , p_{n0c}] with reward r₄. This can occur, for example, when a single session results in more than one evaluation of candidate content (refer, e.g., to candidate items 108 of FIG. 1).

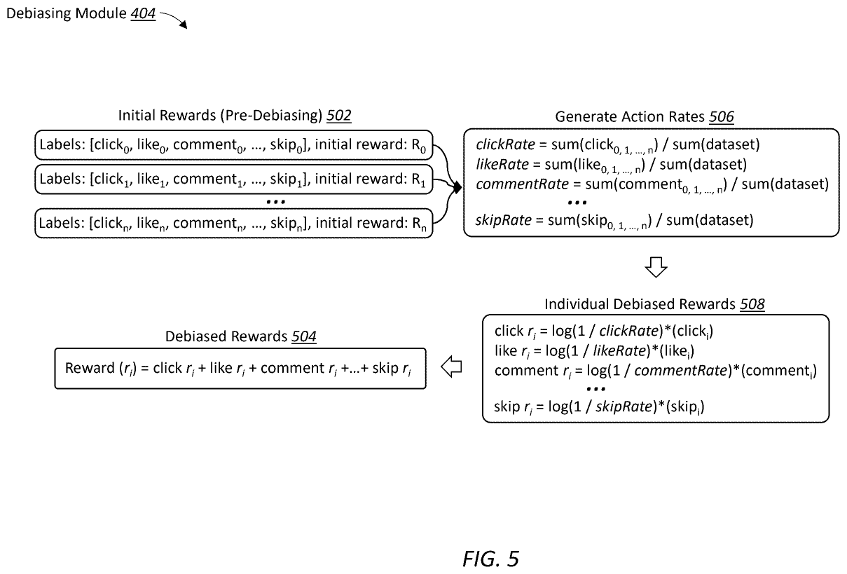

In some embodiments, input 402 is debiased via a debiasing module 404. In some embodiments, debiasing includes modifying the initial rewards (e.g., R₀, . . . , R₆, refer to FIG. 5) to produce debiased rewards (e.g., the rewards r₀, . . . , r₆). In some embodiments, the rewards are debiased according to an inverse log rate. Debiasing is discussed in greater detail with respect to FIG. 5.

In some embodiments, the input 402 (or debiased input 402) undergoes global and/or session level aggregation prior to fitness evaluation. More specifically, input 402 can be passed to session vs. non-session aggregation 406. In session aggregation, data is collected and analyzed at the level of individual user sessions. This means that metrics such as user engagement, interaction patterns, and content consumption are evaluated within the context of a single session. For example, a session might track how a user interacts with a content feed during a single visit, capturing actions like clicks, likes, and shares. This granular view helps in understanding user behavior and preferences in real-time, allowing for immediate adjustments to improve user experience. Non-session aggregation, on the other hand, involves compiling data across multiple sessions to derive insights at a global level. This approach aggregates metrics over a longer period and/or across a larger user base, providing a relatively more comprehensive view of overall trends and patterns. For instance, non-session aggregation can include an analysis of the average engagement rate of all users over a month, identifying which type(s) of content are most popular or which feature(s) drive the most (or most desirable) interactions. As shown in FIG. 4, aggregation 406 leverages both session and non-session aggregation for fitness evaluation. More specifically, the input 402 (or debiased input 402) can be partitioned into a session set 408 and a non-session set 410. Observe that one or more inputs 402 can be common to both the session set 408 and the non-session set 410 (e.g., so, [p₀₀ₐ, p₁₀ₐ, p₂₀ₐ, . . . , pₙ₀ₐ], r₀).

In some embodiments, an evaluation function 412 (refer to the Evaluation Function 1, . . . , Evaluation Function n of FIG. 2) is applied to the session set 408 and/or the non-session set 410 to generate corresponding fitness scores 414. To generate the fitness scores 414, the predictions (e.g., [p₀₀ₐ, p₁₀ₐ, p₂₀ₐ, . . . , pₙ₀ₐ], . . . , [p_{01g}, p_{11g}, p_{21g}, . . . , p_{n1g}], r₆) are modified using the weight mutations 300 for each candidate child (e.g., [X₁, X₂, . . . , Xₙ]). For example, each prediction (e.g., probability to click, probability to like, etc.) can be multiplied by the corresponding weight. The resulting scores 416 can then be sorted (or ranked) as desired. In some embodiments, the highest scores can be ranked higher than relatively lower scores, although other ranking methodologies are possible and within the contemplated scope of this disclosure.

Once sorted, fitness scores 414 can be generated using a predetermined evaluation function. For example, the fitness scores 414 for session so of the session set 408 can include the evaluation function F([SCORE_{b}, r₃], [SCOREₐ, r₀], [SCORE_{c}, r₄]). While not meant to be particularly limited, in a recommendation system the evaluation function F( ) might include discounted cumulative gain (DCG), normalized discounted cumulative gain (NDCG), mean average precision (MAP), precision and recall, the harmonic mean of precision and recall (also referred to as F1 scores), mean reciprocal rank (MRR), hit rate, and/or cumulative gain (CG). Continuing with the previous example, when the evaluation function F( ) is configured for DCG, the fitness scores 414 for session so of the session set 408 can include the evaluation DCG([SCORE_{b}, r₃], [SCOREₐ, r₀], [SCORE_{c}, r₄]).

FIG. 5 depicts a debiasing module 404 for the evaluation module 220 of FIG. 4 in accordance with one or more embodiments. As shown in FIG. 5, debiasing module 404 can take, as input, a set of initial rewards 502 (also referred to as pre-debiased rewards) and can output, based on the input, a set of debiased rewards 504. In some embodiments, the initial rewards 502 are retrieved from, or provided by, the evaluation module 220 (refer to input 402 of FIG. 4). In some embodiments, the debiased rewards 504 represent the debiased input 402 (refer, again, to FIG. 4). In some embodiments, the initial rewards 502 include a set of labels (or predictions). For example, the initial rewards 502 might include a first set of labels: [click₀, like₀, comment₀, . . . , skip₀], a second set of labels: [click₁, like₁, comment₁, . . . , skip₁] and respective initial rewards R₀ and R₁ corresponding to those labels.

In some embodiments, action rates 506 are generated from the initial rewards 502. While not meant to be particularly limited, the action rates 506 can include aggregate metrics derived from the initial rewards 502. For example, in the context of a recommendation network, action rates 506 can include metrics derived from user interactions, such as the number of clicks, likes, comments, and skips observed after delivering content items. In some embodiments, action rates 506 provide a quantitative measure of how frequently each type of interaction occurs relative to the total number of interactions or opportunities for interaction. For example, to generate action rates 506, the debiasing module 404 first collects data on various user actions, represented by the labels in the initial rewards 502 (e.g., a set of labels such as [click₀, like₀, comment₀, skip₀] for one user session and [click₁, like₁, comment₁, skip₁] for another. In some embodiments, the action rate 506 for each type of interaction is calculated by summing the occurrences of that action across all sessions and dividing by the total number of interactions or sessions. For example, a click rate might be determined as equal to the total number of clicks across all sessions represented within the initial rewards 502 divided by the total number of recommendations shown during those sessions. Similarly, a like rate can be defined as the total number of likes divided by the total number of recommendations, and so on. To illustrate further, consider a scenario in which a recommendation network (refer, e.g., to feed service 100 of FIG. 1) logs 1000 interactions in a day, with 200 clicks, 150 likes, 100 comments, and 50 skips. In this scenario, the action rates 506 would be determined as follows: click rate=200/1000=0.20 or 20 percent, like rate=150/1000=0.15 or 15 percent, comment rate=100/1000=0.10 or 10 percent, and skip rate=50/1000=0.05 or 5 percent.

In some embodiments, debiasing module 404 generates individual debiased rewards 508 from the action rates 506. In some embodiments, individual debiased rewards 508 are the inverse log rate of the corresponding action rates 506. Without wishing to be bound by theory, the inverse log rate has been found to improve the reward predictions for sparse objectives, which can otherwise be dominated when other objectives are more relatively more prevalent in the dataset. As used herein, a “sparse objective” refers to a target or goal within a dataset or model that is characterized by infrequent occurrences or a low frequency of events. In the context of machine learning and recommendation systems, sparse objectives are those interactions or outcomes that happen rarely compared to other more common objectives. For example, in a recommendation network, actions like sharing a post or making a purchase might be considered sparse objectives if they occur much less frequently (that is, less than an order of magnitude in frequency) than actions like clicking or liking content. Sparse objectives can pose challenges in model training and evaluation because their infrequency can lead to skewed results, where more common objectives dominate the learning process. Continuing with the previous example, the individual debiased reward 508 for click rate can be determined as click rᵢ=log (1/click rate)*(clickᵢ), referred to herein as the inverse log rate. Advantageously, the inverse log rate is a new way to define a reward (e.g., in contrast to move conventional approaches where PI actions might be weighted equally) which can natively debias objective skew for oversampled objectives such as dwell time.

In some embodiments, debiasing module 404 generates the debiased rewards 504 from the individual debiased rewards 508. For example, the debiased rewards 504 can be defined as the summation of the individual debiased rewards 508, although other techniques, such as weighted-based approaches, are possible and within the contemplated scope of this disclosure.

Turning now to FIG. 6, in some embodiments, one or more of the models (e.g., SPR 106 or an FPR 110 of FIG. 1, candidate models 208 of FIG. 2, etc.) previously described can be implemented in whole or in part as a multilayer perceptron (MLP) 600, which is a type of feedforward artificial neural network that consists of multiple layers of interconnected nodes 602. In this implementation, the MLP 600 includes one or more fully connected layers 604 using candidate features (refer, e.g., to candidate items 108 of FIG. 1) as input (collectively defining an input layer 606). The depth, width, dimensionality, etc., of the MLP 600 need not be particularly limited, and the construction shown in FIG. 6 is merely illustrative.

In some embodiments, MLP 600 includes one or more nodes 602 (neurons) arranged in each of the fully connected layers 604. Nodes 602 in adjacent fully connected layers 604 are connected by weighted edges 610, where the weight of a respective edge represents the strength of the connection between the respective nodes 602. These weights are adjusted during a training phase. In this type of implementation, the weights of the nodes 602 can be set according to the random optimization weight tuning model 200 (refer, e.g., to FIG. 2). In some embodiments, each node 602 in the MLP 600 performs a weighted sum of its inputs, adds a bias term, and then, optionally, applies a non-linear activation function to produce an output. The nonlinear activation function, such as a rectified linear unit (ReLU), sigmoid, or tanh function, can be applied to the outputs of each node 602 to introduce nonlinearity to the output scores.

Turning now to FIG. 7, in some embodiments, one or more of the models (e.g., SPR 106 or an FPR 110 of FIG. 1, candidate models 208 of FIG. 2, etc.) previously described can be implemented in whole or in part using a transformer 700, such as those relied upon in some large language models (LLMs). In some embodiments, transformer 700 includes an encoder 706 trained to generate embeddings (e.g., candidate embeddings, user embeddings, actor embeddings, item embeddings, etc.). While not meant to be particularly limited, the transformer 700 and/or encoder 706 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 7, the transformer 700 begins with an input 702. The input 702 denotes an input provided by a user (or upstream system) and can be represented as a sequence of tokens, individual words or sub-words, from which input embeddings 704 can be generated. The input embeddings 704 represent the tokens within the input 702 as numbers, which can be processed using encoder 706. In some embodiments, a positional encoding 708 can be generated to encode the position of each token in input 702 as a set of numbers. These numbers can be fed into the encoder 706 with the input embeddings 704, allowing the transformer-based architecture to more effectively understand the order of words in a sentence and to thereby generate grammatically correct and semantically meaningful outputs.

The encoder 706 processes the input embeddings 704 and the positional encoding 708 and generates, for the input 702, an encoded representation 710 that captures the meaning and context of the input 702. To accomplish this, encoder 706 applies a series of self-attention transformer layers (or simply, “transformer layers”), which are a series of hidden states that represent the input 702 at different levels of abstraction. The encoder 706 can include any number of these transformer layers, as desired. In some embodiments, the encoded representation 710 is provided to a decoder 712.

The decoder 712 similarly includes a number of transformer layers, as desired, except that the decoder 712 processes an output 714. In many implementations, the output 714 is a right-shifted copy of the input 702, meaning that the decoder 1112 can only use the previous words for next-token prediction. In some embodiments, output embeddings 716 can be generated from the output 714 to represent the tokens in the output 714 as numbers, in a similar manner as described with respect to the encoder 706. A positional encoding 718 can be added to the output embeddings 716 to encode the position of each token in output 714 as a set of numbers. The decoder 712 can be trained by minimizing a loss function (also known as an objective function, which quantifies a difference between a predicted output and a known true value) using, for example, gradient descent. Once trained, the transformer 700 can be used during an inference phase to generate an output 720, which can be thought of as a next-token probability (that is, how likely is the next token in the sequence to be x, or y, etc.). In some configurations, the transformer-based architecture includes a linear layer and softmax layer (omitted for clarity) to transform a raw output from the decoder 712 into the output 714. For example, after the decoder 712 produces a raw output (e.g., output embeddings), the linear layer can map the output embeddings to a higher-dimensional space, thereby transforming the output embeddings into a same original input space as the input 702. The softmax function can be used to generate a probability distribution for each output token in the vocabulary.

In the current implementation, the input 702 can include candidate items 108 (refer to FIG. 1) and output 720 and/or encoded representation 710 can include an interaction prediction score for the candidate item 108 (e.g., whether a user will click the candidate item 108, or share it, or comment about it, etc.). In other words, transformer 700 can be trained to generate, responsive to receiving input 702 including candidate items 108, an output 720 (or encoded representation 710 in encoder implementations) including candidate scores. Those candidate scores can be used to return, responsive to receiving a ranking request 124, a return 126 including, for example, the top K candidate items according to those scores (refer to FIG. 1).

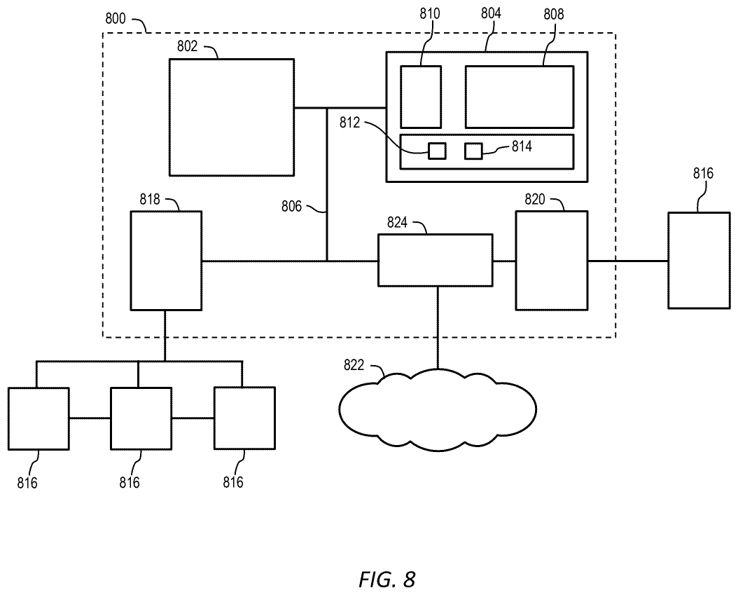

FIG. 8 illustrates aspects of an embodiment of a computer system 800 that can perform various aspects of embodiments described herein. In some embodiments, the computer system(s) 800 can implement and/or otherwise be incorporated within or in combination with the feed service 100 and/or second pass ranker 106 and/or one or more of the first pass rankers 110 described previously (refer to FIG. 1). In some embodiments, computer system 800 can be implemented server-side. For example, a remote computer system 800 can be configured to receive a ranking request 124, and in response, to generate a return 126 including the top K candidates for the ranking request 124. In another example, a remote computer system 800 can be configured to receive candidate models 208, and in response, to select a ramp model 202 for the feed service 100.

The computer system 800 includes at least one processing device 802, which generally includes one or more processors or processing units for performing a variety of functions, such as, for example, completing any portion of the feed service 100 and/or random optimization weight tuning model 200 described previously. Components of the computer system 800 also include a system memory 804, and a bus 806 that couples various system components including the system memory 804 to the processing device 802. The system memory 804 may include a variety of computer system readable media. Such media can be any available media that is accessible by the processing device 802, and includes both volatile and non-volatile media, and removable and non-removable media. For example, the system memory 804 includes a non-volatile memory 808 such as a hard drive, and may also include a volatile memory 810, such as random access memory (RAM) and/or cache memory. The computer system 800 can further include other removable/non-removable, volatile/non-volatile computer system storage media.

The system memory 804 can include at least one program product having a set (e.g., at least one) of program modules that are configured to carry out functions of the embodiments described herein. For example, the system memory 804 stores various program modules that generally carry out the functions and/or methodologies of embodiments described herein. A module or modules 812, 814 may be included to perform functions related to any of the block diagrams described herein. The computer system 800 is not so limited, as other modules may be included depending on the desired functionality of the computer system 800. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 802 can also be configured to communicate with one or more external devices 816 such as, for example, a keyboard, a pointing device, and/or any devices (e.g., a network card, a modem, etc.) that enable the processing device 802 to communicate with one or more other computing devices. Communication with various devices can occur via Input/Output (I/O) interfaces 818 and 820.

The processing device 802 may also communicate with one or more networks 822 such as a local area network (LAN), a general wide area network (WAN), a bus network and/or a public network (e.g., the Internet) via a network adapter 824. In some embodiments, the network adapter 824 is or includes an optical network adaptor for communication over an optical network. It should be understood that although not shown, other hardware and/or software components may be used in conjunction with the computer system 800. Examples include, but are not limited to, microcode, device drivers, redundant processing units, external disk drive arrays, RAID systems, and data archival storage systems, etc.

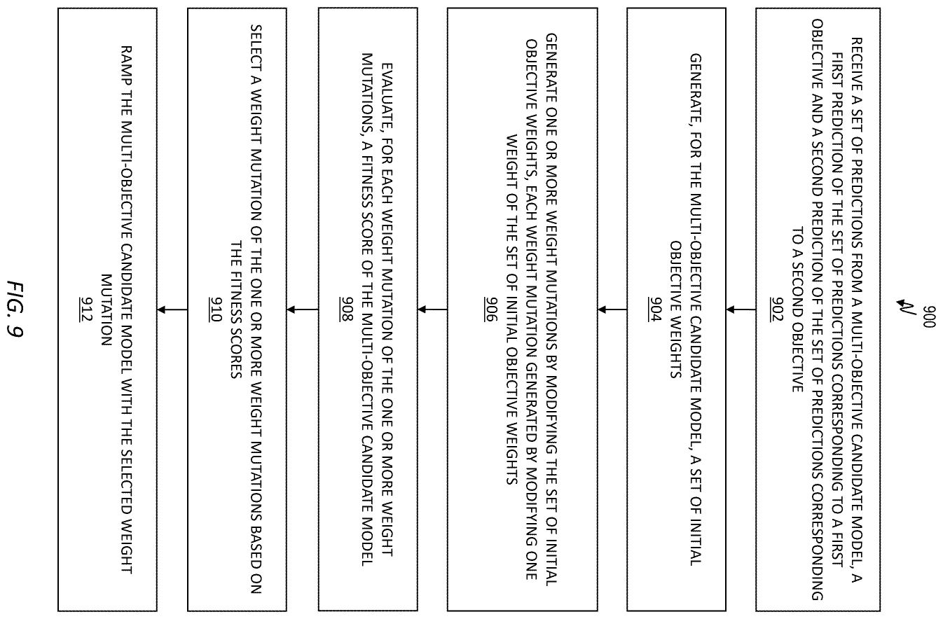

Referring now to FIG. 9, a flowchart 900 for random optimization weight tuning is generally shown according to an embodiment. The flowchart 900 is described with reference to FIGS. 1 to 8 and may include additional steps not depicted in FIG. 9. Although depicted in a particular order, the blocks depicted in FIG. 9 can be, in some embodiments, rearranged, subdivided, and/or combined.

At block 902, the method includes receiving a set of predictions from a multi-objective candidate model. In some embodiments, a first prediction of the set of predictions corresponds to a first objective (e.g., click rate) and a second prediction of the set of predictions corresponds to a second objective (e.g., comment rate).

At block 904, the method includes generating, for the multi-objective candidate model, a set of initial objective weights.

At block 906, the method includes generating one or more weight mutations by modifying the set of initial objective weights. In some embodiments, each weight mutation is generated by modifying one weight of the set of initial objective weights.

At block 908, the method includes evaluating, for each weight mutation of the one or more weight mutations, a fitness score of the multi-objective candidate model.

At block 910, the method includes selecting a weight mutation of the one or more weight mutations based on the fitness scores.

At block 912, the method includes ramping the multi-objective candidate model with the selected weight mutation.

In some embodiments, each weight mutation is generated by adding or subtracting a random value to or from the respective one weight of the set of initial objective weights. In some embodiments, the random value is scaled according to a predetermined constraint on per-generation mutation drift. In some embodiments, the predetermined constraint on per-generation mutation drift is a dynamic value which is learned for each objective of the multi-objective candidate model.

In some embodiments, when generating the one or more weight mutations, modifications to the set of initial objective weights are constrained such that the resulting fitness score is equal to one.

In some embodiments, when generating the one or more weight mutations, modifications to the set of initial objective weights are constrained to maximize positive weights while minimizing negative weights.

In some embodiments, when evaluating the fitness scores for each weight mutation, rewards are debiased according to an inverse log rate of each respective objective of the multi-objective candidate model.

In some embodiments, when evaluating the fitness scores for each weight mutation, the debiased rewards are partitioned into a session set and a non-session set. In some embodiments, when evaluating the fitness scores for each weight mutation, individual fitness scores are determined for each unique session within the session set, and a single fitness score is determined for the non-session set.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGURES illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving a set of predictions from a multi-objective candidate model, wherein a first prediction of the set of predictions corresponds to a first objective and a second prediction of the set of predictions corresponds to a second objective;
generating, for the multi-objective candidate model, a set of initial objective weights;
generating one or more weight mutations by modifying the set of initial objective weights, wherein each weight mutation is generated by modifying one weight of the set of initial objective weights based on a non-global epsilon value comprising a predetermined constraint on per-generation mutation drift that is separately learned for each objective of the multi-objective candidate model;
evaluating, for each weight mutation of the one or more weight mutations, a fitness score of the multi-objective candidate model;
selecting a weight mutation of the one or more weight mutations based on the fitness scores; and
ramping the multi-objective candidate model with the selected weight mutation.

2. The method of claim 1, wherein weight mutations for the first objective are generated by adding or subtracting a first random value to or from the respective one weight of the set of initial objective weights corresponding to the first objective, the first random value having a maximum value defined by a first non-global epsilon value for the first objective.

3. The method of claim 2, wherein weight mutations for the second objective are generated by adding or subtracting a second random value to or from the respective one weight of the set of initial objective weights corresponding to the second objective, the second random value having a maximum value defined by a second non-global epsilon value for the second objective.

4. The method of claim 3, wherein the first non-global epsilon value and the second non-global epsilon value are different.

5. The method of claim 2, wherein, when generating the one or more weight mutations, modifying the set of initial objective weights is constrained such that the resulting fitness score is equal to one.

6. The method of claim 2, wherein, when generating the one or more weight mutations, modifying the set of initial objective weights is constrained to maximize positive weights while minimizing negative weights.

7. The method of claim 1, wherein, when evaluating the fitness scores for each weight mutation, rewards are debiased according to an inverse log rate of each respective objective of the multi-objective candidate model.

8. The method of claim 2, wherein, when evaluating the fitness scores for each weight mutation, the debiased rewards are partitioned into a session set and a non-session set.

9. The method of claim 8, wherein, when evaluating the fitness scores for each weight mutation, individual fitness scores are determined for each unique session within the session set, and a single fitness score is determined for the non-session set.

10. A system comprising a memory, computer readable instructions, and one or more circuitry for executing the computer readable instructions, the computer readable instructions controlling the one or more circuitry to perform operations comprising:
receive a set of predictions from a multi-objective candidate model, wherein a first prediction of the set of predictions corresponds to a first objective and a second prediction of the set of predictions corresponds to a second objective;
generate, for the multi-objective candidate model, a set of initial objective weights;
generate one or more weight mutations by modifying the set of initial objective weights, wherein each weight mutation is generated by modifying one weight of the set of initial objective weights based on a non-global epsilon value comprising a predetermined constraint on per-generation mutation drift that is separately learned for each objective of the multi-objective candidate model;
evaluate, for each weight mutation of the one or more weight mutations, a fitness score of the multi-objective candidate model;
select a weight mutation of the one or more weight mutations based on the fitness scores; and
ramp the multi-objective candidate model with the selected weight mutation.

11. The system of claim 10, wherein weight mutations for the first objective are generated by adding or subtracting a first random value to or from the respective one weight of the set of initial objective weights corresponding to the first objective, the first random value having a maximum value defined by a first non-global epsilon value for the first objective.

12. The system of claim 11, wherein weight mutations for the second objective are generated by adding or subtracting a second random value to or from the respective one weight of the set of initial objective weights corresponding to the second objective, the second random value having a maximum value defined by a second non-global epsilon value for the second objective.

13. The system of claim 12, wherein the first non-global epsilon value and the second non-global epsilon value are different.

14. The system of claim 11, wherein, when generating the one or more weight mutations, modifying the set of initial objective weights is constrained such that the resulting fitness score is equal to one.

15. The system of claim 11, wherein, when generating the one or more weight mutations, modifying the set of initial objective weights is constrained to maximize positive weights while minimizing negative weights.

16. The system of claim 10, wherein, when evaluating the fitness scores for each weight mutation, rewards are debiased according to an inverse log rate of each respective objective of the multi-objective candidate model.

17. The system of claim 11, wherein, when evaluating the fitness scores for each weight mutation, the debiased rewards are partitioned into a session set and a non-session set.

18. The system of claim 8, wherein, when evaluating the fitness scores for each weight mutation, individual fitness scores are determined for each unique session within the session set, and a single fitness score is determined for the non-session set.

19. A computer program product comprising a computer readable storage medium having program instructions embodied therewith, the program instructions executable by one or more circuitry to cause the one or more circuitry to perform operations comprising:
receive a set of predictions from a multi-objective candidate model, wherein a first prediction of the set of predictions corresponds to a first objective and a second prediction of the set of predictions corresponds to a second objective;
generate, for the multi-objective candidate model, a set of initial objective weights;
generate one or more weight mutations by modifying the set of initial objective weights, wherein each weight mutation is generated by modifying one weight of the set of initial objective weights based on a non-global epsilon value comprising a predetermined constraint on per-generation mutation drift that is separately learned for each objective of the multi-objective candidate model;
evaluate, for each weight mutation of the one or more weight mutations, a fitness score of the multi-objective candidate model;
select a weight mutation of the one or more weight mutations based on the fitness scores; and
ramp the multi-objective candidate model with the selected weight mutation.

20. The computer program product of claim 19, wherein weight mutations for the first objective are generated by adding or subtracting a first random value to or from the respective one weight of the set of initial objective weights corresponding to the first objective, the first random value having a maximum value defined by a first non-global epsilon value for the first objective.
